(19) United States
(12) Patent Application Publication
(10) Pub. No.: US 2007/0157321 A1
(43) Pub. Date: Jul. 5, 2007

(54) Method to improve the integrity of internet programs, websites and software

(76) Inventors: Stephen Errico, Charlotte, NC (US); Steven Pfrenzinger, Palm Desert, CA (US)

Correspondence Address: CLEMENTS WALKER, 1901 ROXBOROUGH ROAD, SUITE 300, CHARLOTTE, NC, 28211, US

(21) Appl. No.: 11/509,279

(22) Filed: Aug. 24, 2006

Related U.S. Application Data
(60) Provisional application No. 60/756,263, filed on Jan. 4, 2006.

(51) Int. Cl. H04L 9/32

(52) U.S. Cl. 726/28

(57) ABSTRACT

The current invention is a method to improve the integrity of the internet programs, websites, and software, for example, by revealing the identity of the content provider. In particular, the method ensures the content provider's identity by requiring biometric input unique to the content provider creating a program which converts the biometric information into a unique identification number, for example, and incorporating the unique identification number into internet programs, software, websites, etc. for future reliability. The present invention allows users to know that the content provider's identification be biometrically confirmed, if necessary. It allows the content provider to further protect their intellectual property and to further identify themselves to others to demonstrate their skills.

This application is related to U.S. Provisional application 60/756,263 filed Jan. 4, 2006, and hereby claims the filing date thereof.

### BACKGROUND OF THE INVENTION

1. Field of the Invention

Allowing the anonymity of internet content providers has the unintended consequence of making it easy to introduce malware, spyware, viruses or other harmful content on the internet. The current invention (called Biostamp) is a method to improve the integrity of the internet programs, websites, and software, for example, by revealing the identity of the content provider. In particular, the method ensures the content provider's identity by requiring biometric input unique to the provider creating a program which converts the biometric information into a unique identification number, for example, and incorporating the unique identification number into internet programs, software, websites, etc. for future reliability. The present invention allows users to know the identification of those content providers who voluntarily employ the BioStamp™ system of the present invention and the identification can be biometrically confirmed, if necessary. It allows the content provider to further protect any intellectual property and to further identify themselves to others to demonstrate their skills.

2. Prior Art

Users of computer programs and internet websites recognize the destruction of viruses or harmful programs, such as malware or spyware, which destroy or reposition data and/or programs on a computer, or show content not acceptable to and not wanted by the user. This experience occurs because of the unintended consequences of internet anonymity, which makes it easy for those who are unethical and less scrupulous. The evisceration of a software program, email message, movie, or game is known to every user of the internet. Sometimes the result is that both the hardware (computer, PDA, Blackberry®) and the software no longer function.

Current methods and inventions have addressed the problem but fall short. Public key infrastructure (otherwise known as PKI) and single socket layer (otherwise known as SSL) are an encryption, decryption process or are authentication procedures and protocols designed to produce security-based programs, for example to send top secret data and other information through the internet. Such a process is complex and costly to implement and its focus is on securing the content from unauthorized users. It does not address a user's ability to discern content. It does not allow a parent to restrict a child's use of a computer to non-pornographic sites, for example.

Other companies have website certifications and seals of approvals such as VeriSign® and WebTrust®. Such companies attempt to provide the user with confidence that a particular web company has met predetermined standards and that such companies display the logo seal indicating that the site or software has met such standards. Such methods have improved the confidence in internet commerce such as Paypal® by providing consumer confidence in using credit cards when buying products through the internet.

Another focus to address viruses is anti-virus and anti-spyware tools and programs. Such programs scan a computer for infected programs and sometimes help in repairing such infected programs, but fall short in preventing viruses and spyware from infiltrating programs and are in a constant battle to outwit the virus creator or spyware maker.

Lastly, email tools are often part of the operating software on a computer and such tools provide a blacklist ban based on rule creation to prevent, for example, unwanted emails. For example, if an email contains the word “Viagra”, the computer user may decide not to open the email, place such an email on the blacklist such that it does not appear or capture the attention of the user in the future. Of course, the problem with such email tools is they can create many false positives and the user does not see a message that he/she otherwise wanted.

Thus, there is a need in the industry to have a voluntary system to make software programs, internet email, websites, etc. more accountable by revealing the authorship of such programs, websites, documents, etc. It is unlikely that an identifiable voluntary provider would put malware, spyware, viruses or other harmful content on the internet. The current invention addresses this problem by removing the unintended anonymity of content providers.

### SUMMARY OF THE INVENTION

The present invention, called Biostamp, is a method to improve the integrity of the internet programs, websites, and software, for example, by revealing the identity of the content provider. In particular, the method ensures the content provider's identity by requiring biometric input unique to the provider creating a program which converts the biometric information into a unique identification number, for example, and incorporating the unique identification number into internet programs, software, websites, etc. for future reliability. The present invention allows users to know the identification of those content providers who voluntarily employ the BioStamp™ system of the present invention and the identification can be biometrically confirmed, if necessary. It allows the content provider to further protect any intellectual property and to further identify themselves to others to demonstrate their skills.

In the broadest sense, the present invention related to a method to improve the integrity of the internet, comprising: providing a registration process for internet content providers having unique biometric information, and stamping or embedding a unique identifier into internet content of the content provider. The biometric information can be DNA, retina or iris scan, fingerprint, or voice scan, or two or more of these. The content provider can be a publisher, an author, a contributor, an owner, a programmer, or distributor, or two or more of these.

### BRIEF DESCRIPTION OF THE DRAWINGS

The drawings aid in the understanding of the invention and are not intended to limit the scope of the invention in any manner beyond the scope of the claims.

FIG. 1 is a text-graphic illustration of the problem Biostamp solves.

FIG. 2 is a text-graphic of the solution of the problem and invention.

FIG. 3 is a text-graphic of the content type, the accountability types, and the Biostamp fields.

FIG. 4 is a text-graphic of the function of the administration of Biostamp.

FIG. 5 is a flow chart of the overall invention.

FIG. 6 is a flow chart of the registration process.

FIG. 7 is a flow chart of the stamping process.

FIG. 8 is a flow chart of the user set-up process.

FIG. 9 is a flow chart of the reveal process.

FIG. 10 is a flow chart of the user survey process.

### DESCRIPTION OF THE PREFERRED EMBODIMENTS

In this description, “internet content” means or includes software programs, websites, email, files (pdf, tif, gif, jpeg), drawings, pictures, video clips, audio clips, movies, music, songs, games, pictures, or documents such as word or spread sheet documents, sent or made available by email or other internet means. Some internet content can be big files. Accordingly, a big file can undergo the stamping process of the present invention, to make it acceptable to the receiver.

Additionally, “content provider” means the author, compiler, distributor, programmer, creator or publisher of a software program, website, or document, or any of the other person who associated with the types of internet content mentioned above. This definition is meant to include both those who create (such a musician and lyrist, for a song), as well as those who place content on the internet (publisher or distributor). Thus, the content provider may refer to two or more of the above people.

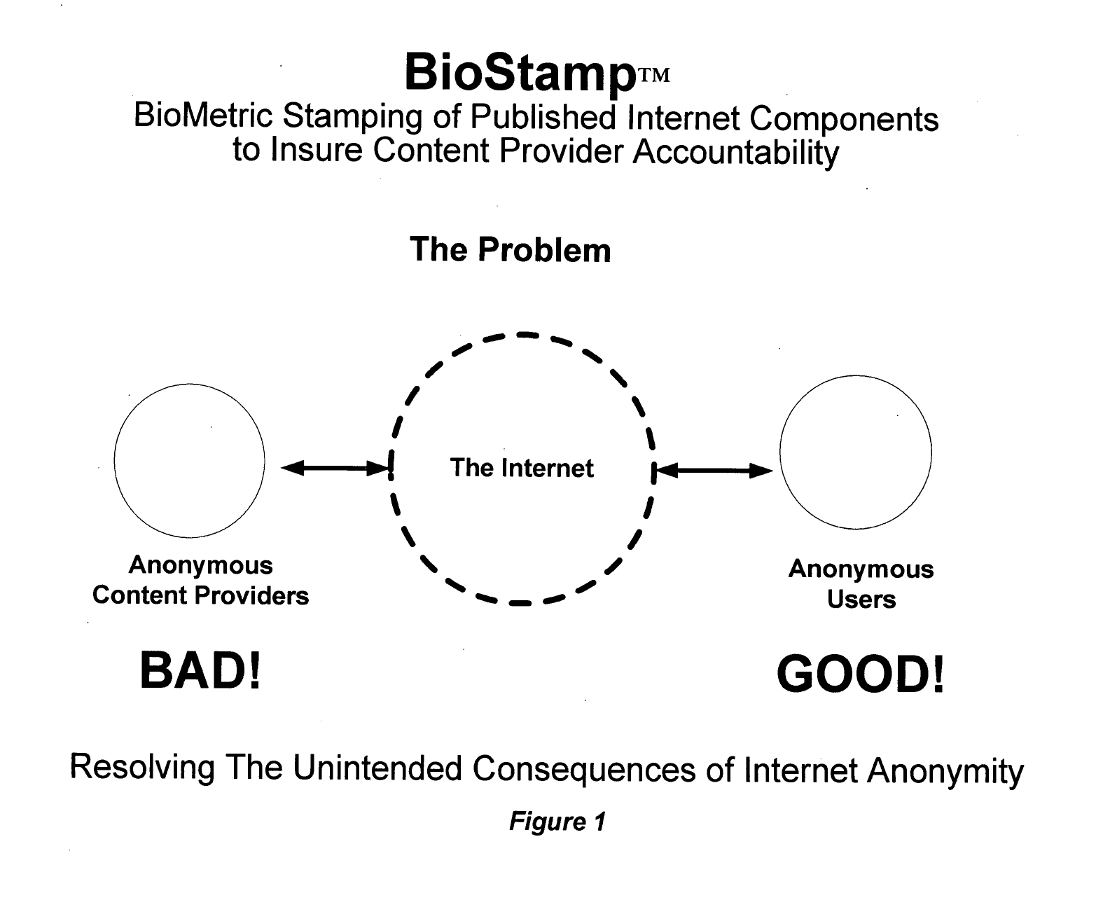

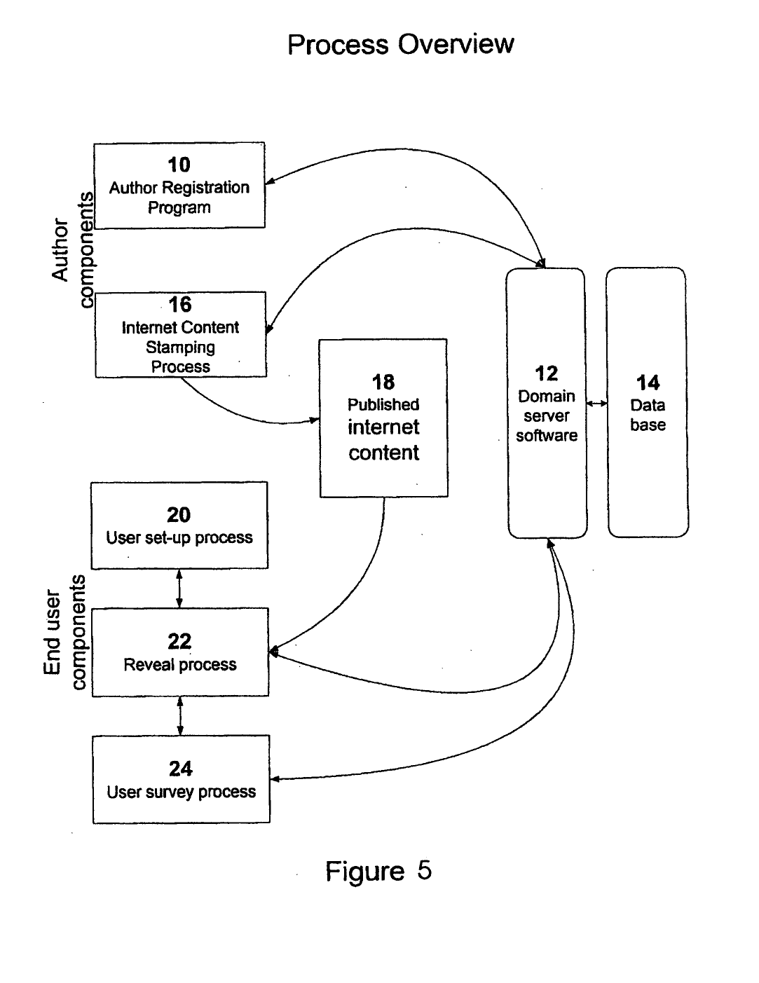

The present invention consists of the content provider voluntarily registering his/her identification in such a way that it becomes unique to them and stamping any created internet content such as software, email, etc., with a unique identification. The invention requires domain software to permit an author to register biometrics that are unique to such a person such as an iris scan, a fingerprint scan, a voice print, DNA, etc. and to create a database in which such information resides. The second stage of the invention, begins after the content provider registers with the BioStamp™ domain database, and is to authenticate or stamp internet content, and embed that information within the internet content. The third phase of the invention occurs when the public uses the authenticated internet content. The public has a setup program to control what he/she wished to see, a reveal program that permits the user to determine the reliability of the internet content, and a user's survey to challenge any “inaccurate” information given by the internet content provider. The problem and solution is a text-graphic illustration shown in FIGS. 1-4. The specific steps are described more fully with respect to FIGS. 5-10.

FIG. 1 is a text-graphic of the Biostamp invention showing the problem associated with anonymous content providers. While anonymous users are desirable for preventing an invasion of privacy, anonymous internet content providers permit children to view pornographic internet materials.

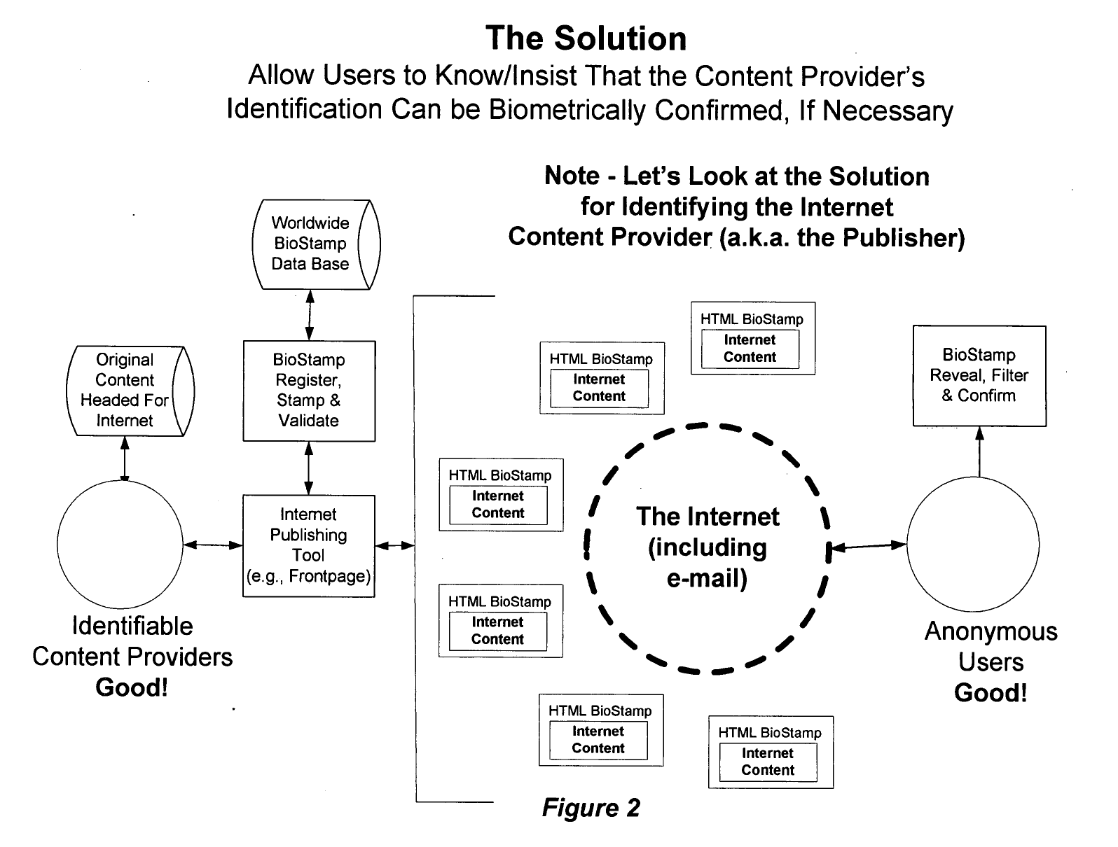

FIG. 2 is a text-graphic showing the solution of the Biostamp invention to the problem of the anonymous internet content provider. The solution is to establish a worldwide Biostamp data base to register, stamp and validate internet content, and fix that stamping to the internet content itself so that a user has a procedure to identify the content provider.

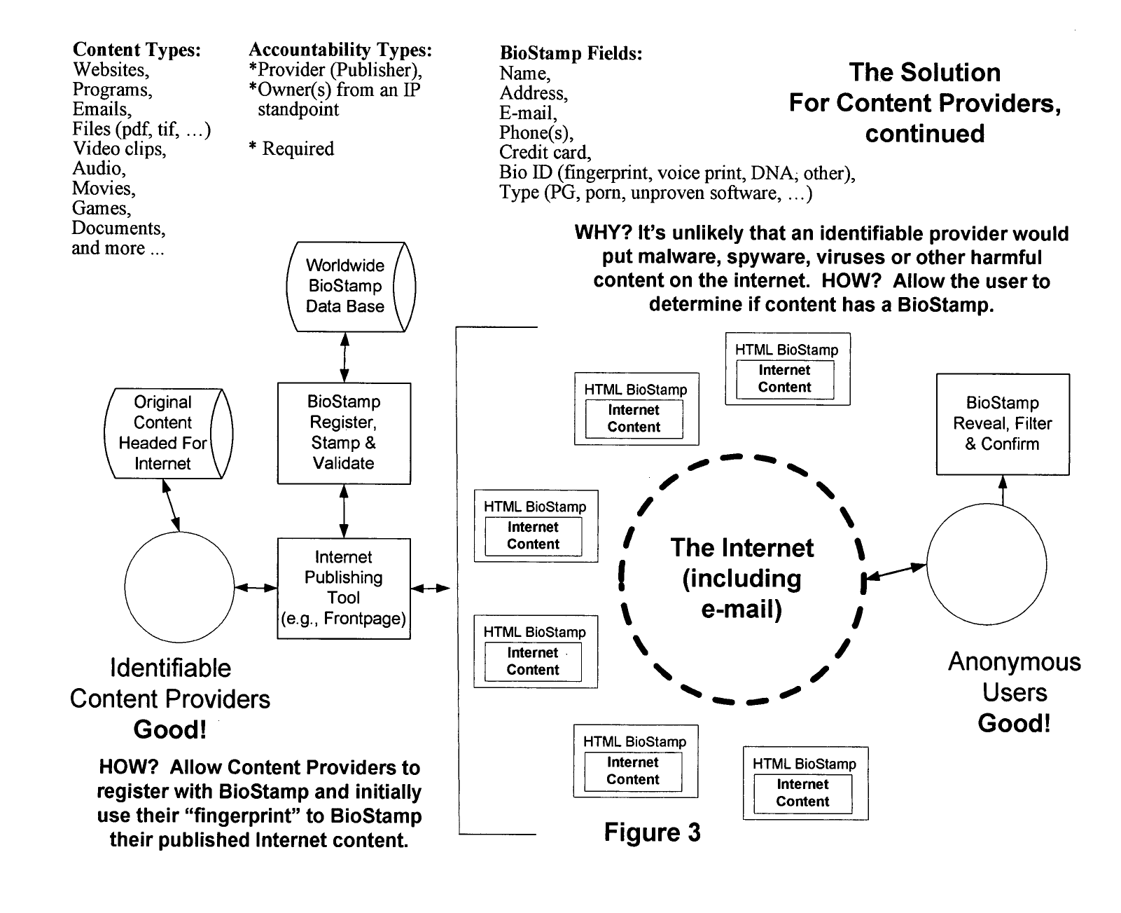

FIG. 3 is a text-graphic showing the types of internet content, those who should be accountable for providing or placing the internet content on the internet, and stating what is typically in the Biostamp field “stamped” on or in the internet content.

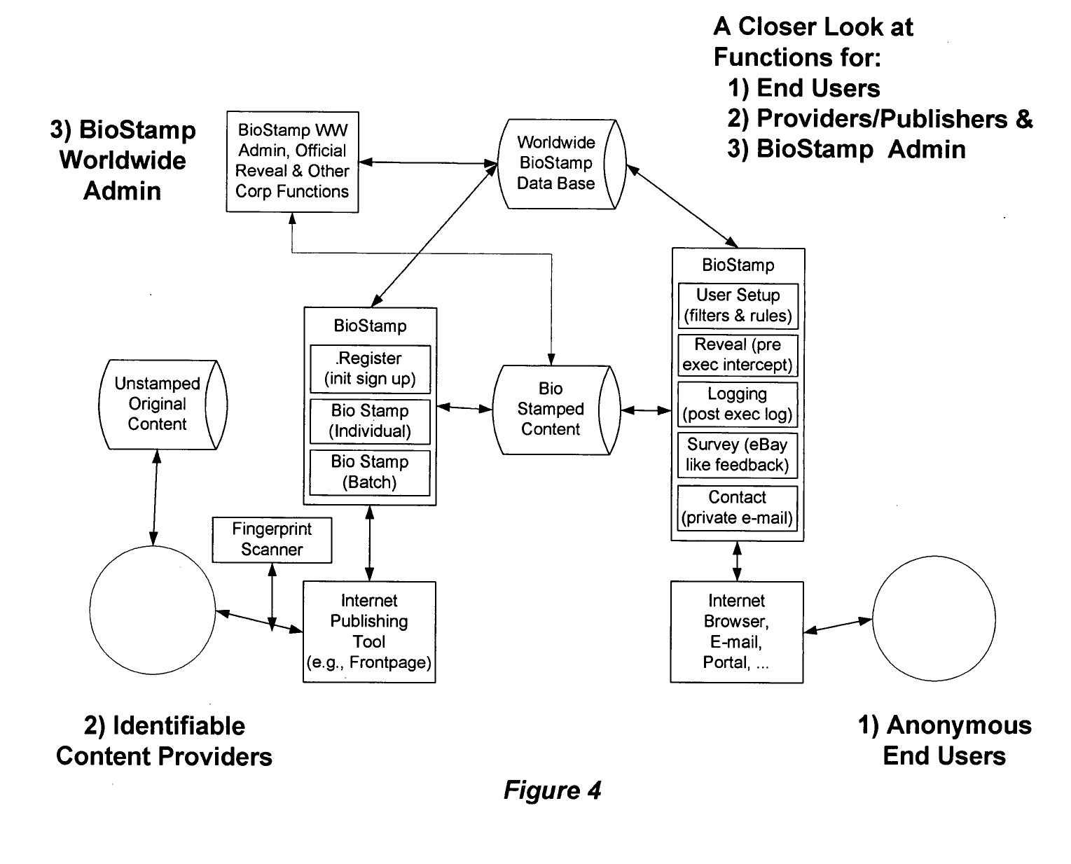

FIG. 4 is a text-graphic showing an overview of the Biostamp process, including the user set-up program, the reveal program, the survey program and the contact program.

FIG. 5 is an overall view of the method of the present invention. The overall process requires three distinct groups having input. First, there is the content provider, second there is the controller of the database and software used to control the database, and third there is the public (user). The content provider calls for the registration program 10 that requires the content provider to register certain simple data in a database 14 by using a server software program 12. The content provider creates an internet content program 18. The content provider authenticates this internet program 18 by a stamping process 16. The stamping process includes a subroutine where the program 18 has a label area in the rendering of the first page of the program (the first page of the program 18 that appears on the computer screen) where the hash number, the unique and specific information is incorporated into the program.

Of course, each internet content program can undergo more than one stamping process, so as to cover all those covered by the term “content provider”. For example, if the internet content program is a song, the lyricist and the musician (music creator) may have the song stamped. Then when a publisher places the song (makes it available for purchasing on the internet) on the internet, the song may undergo the stamping process yet a third time. Accordingly, the song may have 3 hash numbers, etc., thereon (or more).

The public user can determine what internet content they wish to view by using the setup program 20 to create rules to prevent certain types of internet content from being seen. When the user views internet content 18, and the content is not what the user wants to see, the user can employ the reveal program 22 to ultimately learn the identity of the content provider. Thereafter, the user can conduct a survey program 24 to inform the database 14 of any content provider errors.

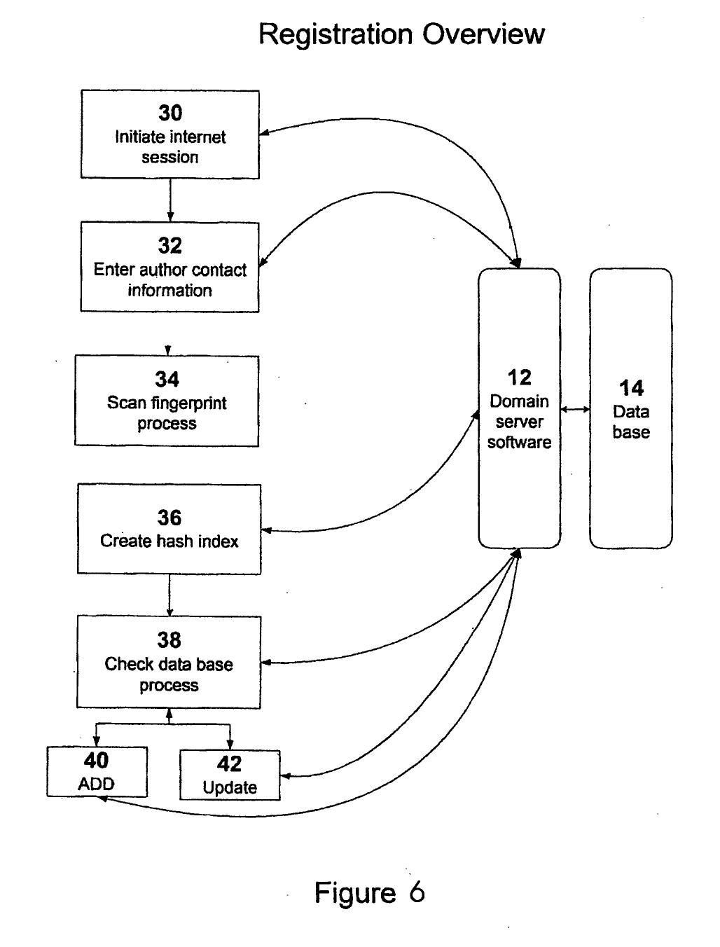

The registration program 10 by the content provider is a series of steps, shown in FIG. 6, wherein the content provider initiates a web session 30 by contacting the domain server 12, and initiating the software that asks for certain data. The content provider enters the simple contact data 32 such as name, address and phone number (specific information), and inputs biometric information 34. The biometrics of the content provider are employed because such information is unique to each person and the content provider can be sure that only he/she has created, and/or modified his/her internet content 18. For example, fingerprints, retina or iris scan, voiceprints, DNA, and other such biometric information can insure the identity of each person separate and distinct from any other person (a unique biometric identifier). For purposes of explaining the invention, the biometric information described from hereon will be fingerprints. Nevertheless, those skilled in the art realize that other biometric information can be obtained and used in the present invention in the same manner as fingerprints. Fingerprinting can simply be inputted into a database 14 by using fingerprint scanners commonly available and sold under many different brand names including Logitech© and Microsoft®.

Once the content provider has registered this simple information, the database registry creates a unique hash index 36, such as a unique 24-digit number. How the domain server creates unique hash index numbers (a unique identifier) is conventional and known to those skilled in the art as a hash index number generator. Thus the hash index in the present invention is a number that is created by software using the person's name, address, telephone number (the specific information) and unique biometric information, or other non-relevant data from the content provider, or perhaps just a random large number is generated based on no data from the content provider. Although the invention is explained in terms of a 24-digit number, the actual size of the created hash index number is variable, but using 24 digits would currently allow every person on the earth (at the time of filing this application) to have their own unique number. Obviously, a 30-digit number or even larger could be employed. Alternatively, a 20-digit number could also be employed. Although the hash index is recited in terms of numbers, it could of course, include letters, symbols or other such unique identifiers to aid in the creation of a unique number, or number/letters, etc. for each person.

The domain server, through a hash index generator, creates a hash index number 36 that is sent to the content provider, along with the specific information and all is also recorded in the database 14. Of course, a content provider could create more than one hash index number by using several different fingerprints such as a left hand thumb print, a right hand thumb print, and/or left index finger, or right index finger, or a combination of some or all of these. The database 14 now includes limited information about the content provider such as the name, address, and telephone number, along with the hash index number. The content provider can then check the data 38 in the database 14 for completeness and to ensure the correctness of the data and add 40 or update 42 any additional information.

In summary, the domain registry initiates a web session by contacting the domain server software, the content provider enters certain personal data such as the name, address, telephone number, etc. (the specific information), scans the unique biometric information of the content provider, such as fingerprints, then creates a unique hash index number and such information goes into the database. The content provider then checks the database and adds or updates the information therein. For example, if the content provider's name changes, such as by marriage, or the address or telephone number changes, the database can be updated, continuously. If the content provider is new, then his/her information is simply added to the database.

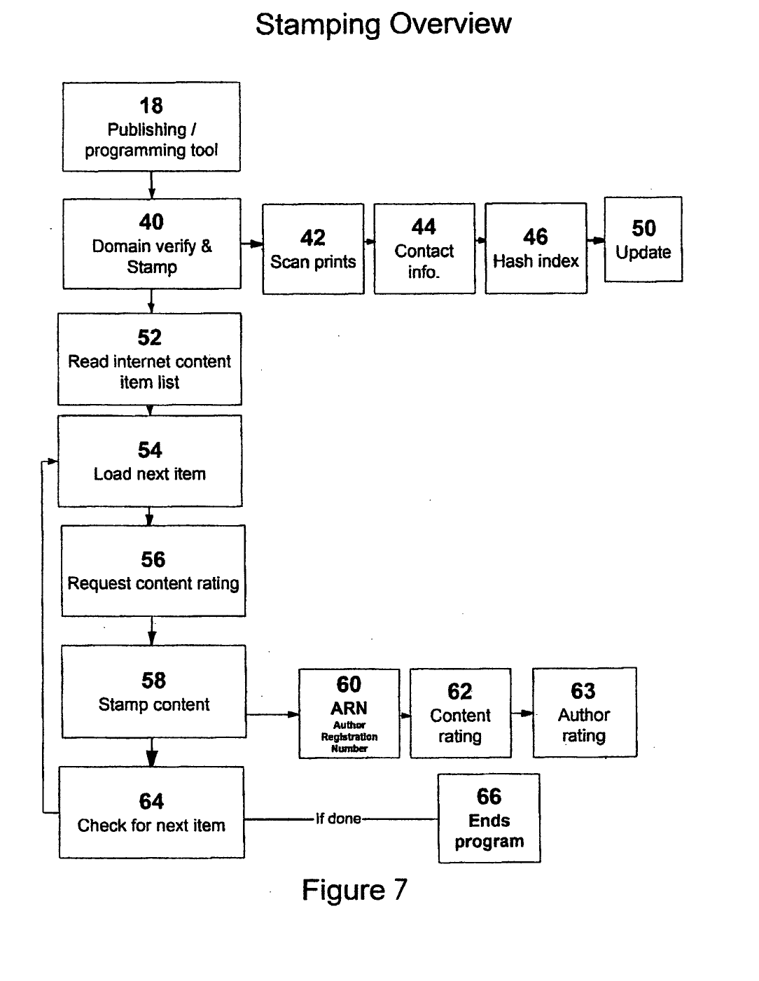

The next phase of the invention is the stamping procedure 16 illustrated in FIG. 7. When a content provider creates a new work 18 or merely wants to stamp an existing internet content, he/she then contacts 40 the domain server 12 (see FIG. 5), and enters a biometric scan 42 of a fingerprint, for example, then enters the contact information 44, such as name, address, and telephone number, and then enters the content provider's hash index number 46. If the content provider needs to update the information since the date of any initial registration program, the content provider can now update the information 50 in the database (shown in FIG. 5). When the information is correct, the domain server requests the document list 52 to be stamped i.e., the list of new or existing internet content programs that the content provider wants authenticated and rated. The first internet content 18 on the document list is loaded 54 such that the domain server recognizes it as needing to be stamped and rated. Next the domain server requests the content provider's initial rating guide 56. The rating guide may include many different categories, such as for example a letter or number to indicate that the content is for children only, such as children educational tools, teenagers, or adult content only, such as pornographic websites or adult educational tools, or is related to sexual medicines such as Viagra, etc., or extreme violence, or it can relate to a particular industry such as books or tapes for sale through the internet, or athletic exercise equipment for sale through the internet, etc. The content suitability rating 56 can also be a business guide rating, where all persons in the marketing division, for example, such that the information is suitable or designated for only those in the marketing division. It can be a music rating designating jazz, classical, latin, pop100, x-rated lyrics, paid customers, or kids music, for music provided through the internet. As is apparent, a person or entity can create any type of custom suitability rating depending on the user, or the user's preferences.

With the standard content provider rating guide, the content provider assigns each internet content program a rating 62. Thus when requested 56 by the server 12, the content provider responds to the domain server by providing the rating 62. The domain server software stamps 58 the loaded internet content with the content provider's hash index number 60 (a unique identifier) and the guideline rating 62. The rating 62 becomes part of the specific information. The hash index number 60 and the specific information, including the rating 62, are embedded into the internet content, in a location known to the content providers of such internet content, such as the PICS label area, but otherwise not visible on a user's screen or normally accessible as part of the user program. This embedding of a unique number or hash index number is “stamping” the document. Of course, the embedding may also include the rating and other information as desired. But the essence of the present invention is to create a hash number or number/letter combination, or a unique combination of symbols, to create a unique identifier, for example, that will be known to the content provider. However, the information is accessible as disclosed later.

If the content provider needs to update 50 an existing internet content program, to correct an error in the content provider's guideline rating 56, for example, the existing internet program must be submitted to the domain server. The domain server verifies that the existing internet program 18 contains the hash index number of the content provider. Then the domain server requests the content provider's new guideline rating. The content provider replies with the new rating 56 and the domain server re-stamps 62 the existing internet content 18 program with the new rating 63.

Once the first loaded internet content program is stamped and rated, the domain server requests 64 the next document to be loaded 54. This document (internet content) is stamped with the content provider's rating and the hash index number using the same process as described previously. This process continues until all documents on the list 52 have been loaded 54, rated 56 and stamped 58. After the last document has been rated and stamped, the stamping process is terminated 66 by the domain server.

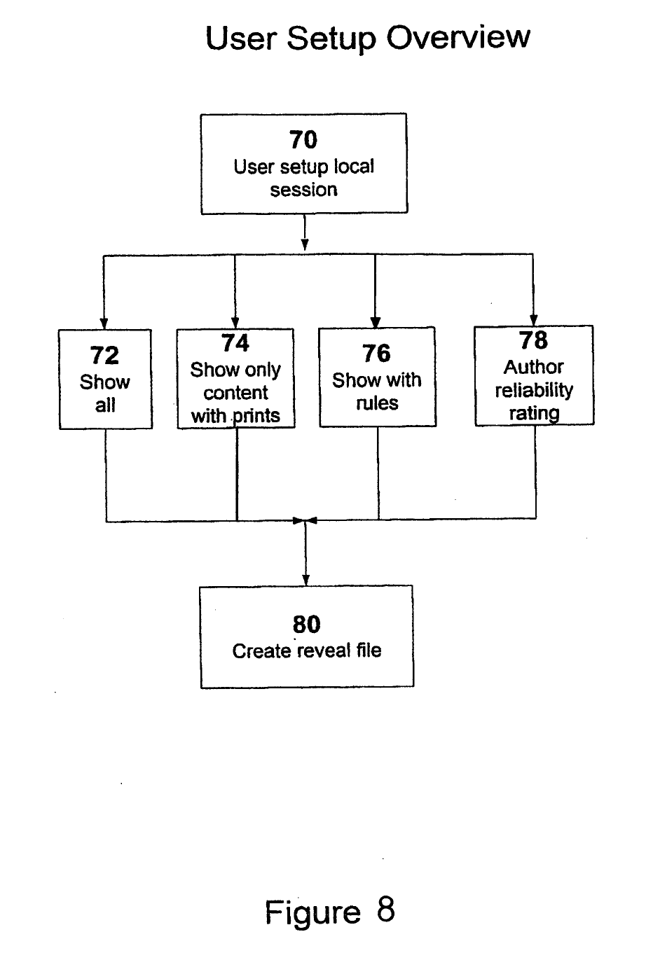

Before a user initiates or uses the internet content, the content provider has registered his/her information and unique biometric identifier with the database. Now the user wants to open the internet content that has a unique hash index number and the content provider's rating. To do this, the user must set-up their viewing preferences on the computer he/she is using. This can be accomplished by using internet tools such as those associated with Microsoft's Internet Explorer. As illustrated in FIG. 8, a public user seeks to use the software or internet website but can first access the setup program for the internet content. The setup program is obtained from the users browser program or tool bar on the hard drive of the user's computer. The setup program 70 would, for example, allow the user to view everything 72, including pornographic materials, or view only internet content which is properly authenticated and stamped 74, or view only the internet content that has a desired content provider's guideline rating 76 such that it meets the user's desire to avoid websites the user finds offensive. It is within the scope of the present invention that the set-up program 70 can also stop further, future undesired content from entering your email or your computer in general. Moreover, the set-up program can also allow the user to view only the internet content which has an content provider's reliability rating 78 acceptable to the user, for example, 75% or higher. Content provider reliability ratings will be further explained later.

Once the primary user has initiated the setup program, the primary user can setup the same controls for all potential users, such as an adult controlling what content goes to a child. Now the setup program will be determinative of what can be exhibited to a user, by permitting viewing of only those programs or internet content which meets the user's specification. The setup program now having the user's preferences is retained on the user's computer. Based on the user's selections, a file 80 is created to reveal the rating, etc of the programs. Once the user has set these rules for all users of that particular computer, for example, then only the permitted internet programs will load onto the computer. If the user has indicated that he wants to see everything “show all” then the entire program is immediately read without further delay. Should the user invoke certain rules that will determine whether the program will open or not, those rules will be implemented and depending on the rules, the software program may or may not be opened. For example, a parent may use the set-up program 70 to control what a child can view, however, it is within the scope of the present invention that the parent or administrator can override an unrated internet content and permit the child to view it after the parent reviews it.

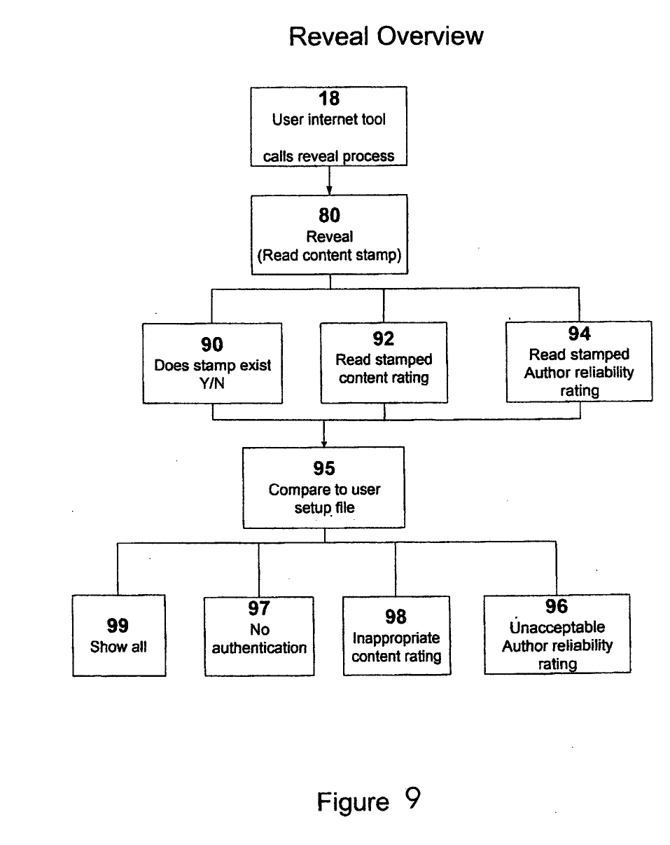

FIG. 9 illustrates the reveal program. Reveal is the actual subroutine or program that through the setup program permits internet content 18 to be loaded on the viewer's hardware (a devise capable of downloading internet content), such as a local computer, PDA, phone, etc. For example the user attempts to enter a website (internet content 18,) and before such website is displayed on the computer, the setup reveal file 80 is obtained through the browser. Then the reveal program determines if the internet content 18 is authenticated by the stamping process 90 (either yes or no), determines the content provider's guideline rating 92, determines the content provider's reliability rating 94, and compares 95 that with the user's rules in the setup file 80 (see FIG. 8). Once these criteria meet the user's setup file rules, the internet content 18 is admitted 99 and is then shown on the user's computer screen. If the internet content does not meet the user rules, no access is permitted and a one or more screens appear explaining why, namely: unacceptable content provider reliability rating 96, no authentication 97, and/or inappropriate content provider's rating 98. Presuming that an internet content program 18 has now loaded on the user's computer in accordance with any specific rules, and the user enters the content software or website by starting the program, if after using the program, the user is satisfied, the user terminates the program and this invention has accomplished its purpose. However, should the user be dissatisfied and conclude that the content provider's guideline rating is inaccurate, the user can request a reading of the authentication stamp such that it reveals the content provider, the initial guideline rating, and any reliability percentage index that is currently in user. In a second embodiment of the present invention, the dissatisfied user can only request a reading of the content provider's hash number and guideline rating. Should the user disagree with the guideline rating initially provided by the content provider, the user by means of the user's survey can provide input to other users, the content provider, and the database.

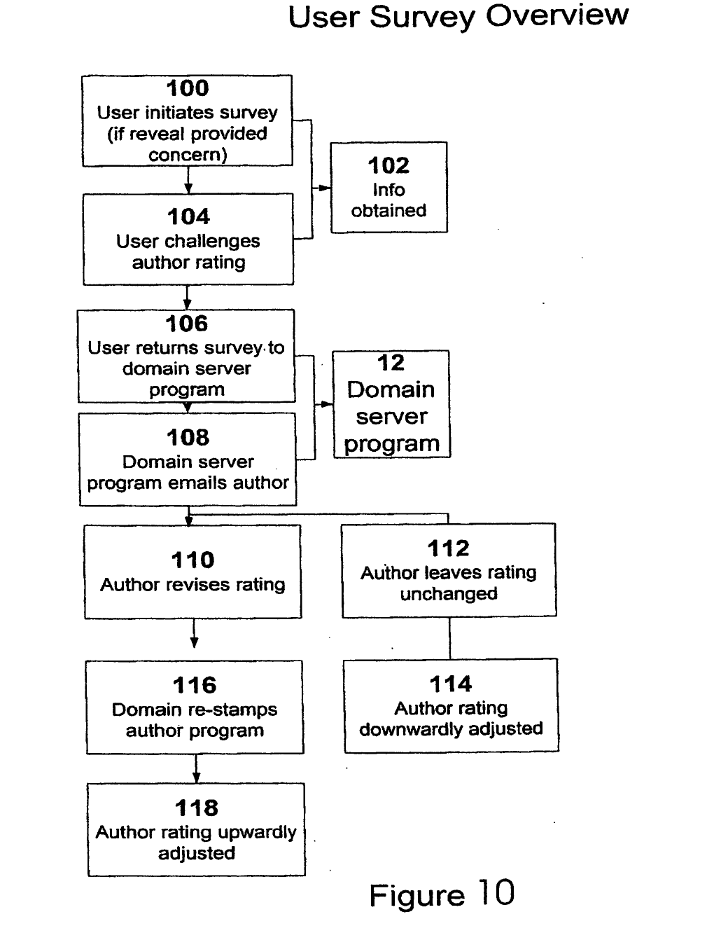

The user survey program is shown in FIG. 10. The purpose of the user survey is to provide input to other users and to the content provider relative to the guideline ratings the content provider initially provided to the work, provide the content provider with an opportunity to amend the ratings, and to impart a reliability factor to the content provider such that users would know whether the content provider is reliable or not.

The user survey initiates with a request 100 to the domain server 12 to take the survey. The request is part of the embedded program or information in the internet content 18. In the first embodiment of the present invention, the user can cause the publisher's simple information, such as the name, address, telephone number, and rating to be revealed for that specific internet content program 18 as indicated by 102. The survey asks the user if he/she wishes to challenge the rating 104 by the content provider of the work or internet content 18. The user responds and that response 106 is recorded on the database via the domain server software. The content provider is emailed a copy of the response 108 (an act accomplished by the domain server software) and may revise 110 the initial guideline rating that was given in view of the user's survey, or make no change 112 to the guideline rating. Should the publisher not invoke any change, the publisher's initial rating of 100% reliability satisfaction drops below 100% as indicated by 114. If the content provider agrees with the user's ranking, the program will then be re-stamped 116 with the new guideline rating by the content provider and that new rating is recorded on the database 14. The reliability index of the content provider is then amended 118 to again reflect 100% reliability. Thus, the present invention includes a method to adjust the reliance on the content provider's rating of the work based on user surveys. The process includes the ability of the content provider to promptly adjust the rating made for the document or internet content to avoid the erosion of their reliability rating.

In the second embodiment of the present invention, the information 102 obtained by the user is simply the unique hash index number and the content provider's rating. The user still returns the survey, but does not learn the actual name, address and telephone number of the content provider. However, the domain server 12 matches the hash number index with the simple information of the content provider and sends the content provider the challenged rating by the user. All other aspects of FIG. 10 are the same, except the identification of the content provider has not been given to the user. However, in the event the internet content 18 has a destructive virus, for example, the legal system can request the simple information from the domain server software to identify the content provider, so that the authorities (policemen) can question or arrest him/her. In this second embodiment, the identity of the content provider is protected from all users, until spyware or virus programs are run by the user. Then the user can get the authorities to obtain the information for the purpose of obtaining an arrest warrant, etc.

The current invention is a better solution for users as they will receive active notification of web content issues prior to activation or display of the particular internet content. They can choose to dial in various rules to suit all the users of the computer. If a particular program has no authentification stamp, the user can decide whether or not to view the website or program. In a sense, viruses and internet content programs that are undesired can be avoided. An example of the use of this invention is a child using the invention while experiencing the internet. In this case, a child that is searching for Barbie would not be shown results that include porn sites. Another example is the selection of a site that triggers the downloading of unwanted spyware programs. This negative or unwanted outcome has harmed the internet user and the current invention permits each user to select exactly what they wish to view with no surprises. Because the identify of the content provider is known, and can be verified through a biometric scan of the content provider, such as fingerprinting, the system is more reliable than any of the current inventions or processes available today. Not only does this program help protect the user, it protects the content provider in that no content provider will get a bad reputation unless or until user's surveys demonstrate the problem with an unscrupulous content provider. Those content providers, on the other hand, that are scrupulous, have no trouble providing the contact information. To prevent one content provider from providing the competition with unsatisfactory ratings, each content provider has a hash number based on biometric information, the name, address and telephone number such that the reliability of the system can be maintained.

Thus it is apparent that there has been provided, in accordance with the invention, a method that fully satisfies the objects, aims, and advantages set forth in the description. While the invention has been described in conjunction with specific embodiments, it is evident that many alternatives, modifications and variations fall within the spirit and broad scope of the invention and claims.

What is claimed is:

1) A method to improve the integrity of the internet, comprising: providing a registration process for internet content providers having unique biometric information, and stamping or embedding a unique identifier into internet content of the content provider.

2) The method of claim 1, wherein said biometric information can be DNA, retina or iris scan, fingerprint, or voice scan, or two or more of these.

3) The method of claim 1, wherein said internet content comprises a website, software, emails, video clip, audio content, movie, game, files, or documents.

4) The method of claim 1, wherein said content provider comprises a publisher, an author, a contributor, an owner, a programmer, or distributor, or two or more of these.

5) The method of claim 1, wherein said registration process includes the steps of providing a data base accessible to said content provider, entering specific information by said content provider into said data base, including said unique biometric information, and generating a unique identifier by the data base for said content provider.

6) The method of claim 5, wherein said unique identifier can be a hash number, a combination of letters and numbers, a combination of symbols, or a mixture of these.

7) The method of claim 5, wherein said specific information can include name, address, phone number, email address, and content suitability rating for the internet content of the content provider and optionally a content provider rating provided by said data base.

8) The method of claim 7, wherein said content suitability rating can be a general rating, an adult rating, a pornographic rating, a teen-age rating, a kids rating, an extreme violence rating, a business rating, a custom rating, a music rating, or an industry rating.

9) The method of claim 7, wherein said step of stamping or embedding includes incorporating said unique identifier and specific information into said internet content in a subroutine program in said data base such that it is normally not visible or does not normally interfere with the function or purpose of the internet content.

10) The method of claim 9, wherein said subroutine program includes a process to update said specific information, and optionally said unique identifier or said content provider rating, or add another unique identifier.

11) The method of claim 1, wherein said step of stamping or embedding includes a listing program in said data base that can read the number of internet contents items desired to be stamped.

12) The method of claim 11, wherein said listing program loads the next internet content item on said list, if any, such that the stamping or embedding step can be executed on said next item, until all items are stamped.

13) The method of claim 7, further comprising a reveal program comprising the step of revealing if said internet content has a BioStamp, reveal the details of said specific information, said suitable content rating and said optional content provider's rating to a viewer of said internet content, said reveal program also comprising at least in part an internet tool on said viewer's hardware.

14) The method of claim 13, wherein said reveal program further includes the step of creating, for an internet content viewer or user, a setup file to specify the user's preferences on content provider's ratings and suitable content ratings.

15) The method of claim 14, wherein said reveal program includes the steps of viewing all internet content and suitable content rating and optional content provider rating, or viewing only the internet content, suitable content rating and author rating that meet the user's preferences.

16) The method of claim 7, further including the steps of initiating a user survey program that permits the user to challenge any of said specific information, suitable content rating or content provider rating, returning said survey program to said data base, forwarding the internet content provider a copy of said survey, and allowing said internet content provider to amend or leave unchanged any of said specific information, said suitable content rating, or author rating.

17) The method of claim 16, wherein said challenge comprises the step of setting forth reasons for challenging anyone of said specific information, suitable content rating or author rating.

18) The method of 16, wherein said step of forwarding said internet content is accomplished by said data base.

19) The method of claim 16, wherein the step of allowing said internet content provider to amend or leave unchanged further comprises allowing said internet content provider to adjust or amend anyone of said specific information, suitable content rating, or content provider rating.

20) The method of claim 1, wherein said step of proving a registration process includes the step of obtaining the unique biometric information from said content provider and forwarding said biometric information to said data base.
